(19) United States
(12) Patent Application Publication
(10) Pub. No.: US 2020/0365310 A1
(43) Pub. Date: Nov. 19, 2020

(54) INDUCTOR MAGNETIC-CORE STRUCTURE

(71) Applicant: TAI-TECH ADVANCED ELECTRONICS CO., LTD., Taoyuan City (TW)

(72) Inventors: Hsiang Chung Yang, Taoyuan City (TW); Pao Lin Shen, Taoyuan City (TW); Ming Yen Hsieh, Taoyuan City (TW)

(21) Appl. No.: 16/409,885

(22) Filed: May 13, 2019

(51) Int. Cl. H01F 27/24

(52) U.S. Cl. CPC H01F 27/24; H01F 27/2823

(57) ABSTRACT

An inductor magnetic-core structure comprises a magnetic-core main-body set with a first flange and a second flange; wherein a first electrode, a second electrode, a third electrode, and a fourth electrode are set on the first flange; wherein a first groove is set on the first electrode, and a second groove is set on the fourth electrode; wherein a fifth electrode, a sixth electrode, and a seventh electrode are set on the second flange; wherein a third groove is set on the fifth electrode, and a fourth groove is set on the seventh electrode; Through the third electrode and the fourth electrode are laterally adjacent and are vertical arranged with respect to the first electrode and the second electrode, and the third electrode and the fourth electrode are set on the fourth contact-point; it does not need to design a short-circuit line on the circuit board additionally.

### (a) TECHNICAL FIELD OF THE INVENTION

The present invention relates to a magnetic-core, and especially relates to an inductor magnetic-core structure.

### (b) DESCRIPTION OF THE PRIOR ART

Please refer to FIG. 1, generally the inductor used for surface-mounting on the circuit board is mainly set with a conventional first electrode A21, a conventional second electrode A22, a conventional third electrode A23, a conventional fourth electrode A24, a conventional fifth electrode A25, a conventional sixth electrode A26, and a conventional seventh electrode A27 respectively at two ends of a conventional inductor magnetic-core A2; wherein the conventional electrodes A21, A22, A23, A24, A25, A26, and A27 can be correspondingly and oppositely bonded and connected with the first contact-point A11, the second contact-point A12, the third contact-point A13, the fourth contact-point A14, the fifth contact-point A15, the sixth contact-point A16, and the seventh contact-point A17 of the circuit board A1 through the surface-mount technology; thereby achieving the effect of convenient manufacture in the manufacturing process.

The conventional inductor magnetic-core A2 can be quickly bonded with the circuit board, but between the contact-point A13 and the fourth contact-point A14 needs to additionally add a short-circuit line A3 on the circuit board; and when adding a short-circuit line on the circuit board, it is often inconvenient for the design because of adding an additional process step and needing to consider the design of the layer plates of the circuit board.

### SUMMARY OF THE INVENTION

In view of the above problems of the inductor magnetic-core of the prior art, it is an object of the present invention to provide an inductor magnetic-core structure.

In order to achieve the above object, the present invention provides an inductor magnetic-core structure, which comprises a magnetic-core main-body set with a first flange and a second flange at both ends of the magnetic-core main-body; wherein a first electrode, a second electrode, a third electrode, and a fourth electrode are set on the first flange; wherein a first groove is set on the first electrode, and a second groove is set on the fourth electrode; wherein the third electrode and the fourth electrode are laterally adjacent and are vertical arranged with respect to the first electrode and the second electrode; wherein a fifth electrode, a sixth electrode, and a seventh electrode are set on the second flange; wherein a third groove is set on the fifth electrode, and a fourth groove is set on the seventh electrode; wherein the third electrode and the fourth electrode are set on the fourth contact-point of the circuit board, so that it does not need to design a short-circuit line on the circuit board additionally; thereby achieving the effects of convenient manufacture and reducing the circuit design.

Furthermore, through the first groove, the second groove, the third groove, and the fourth groove set by the present invention can be used to support the fixing points for winding wires; therefore the applications and variations of the winding-wires can have more kinds and can control the winding directions of the winding-wires (clockwise or counterclockwise) according to the requirements; thereby achieving the effects of easy manufacture and easy change.

### BRIEF DESCRIPTION OF THE DRAWINGS

FIG. 1 is a combination schematic diagram of a conventional inductor and a circuit board.

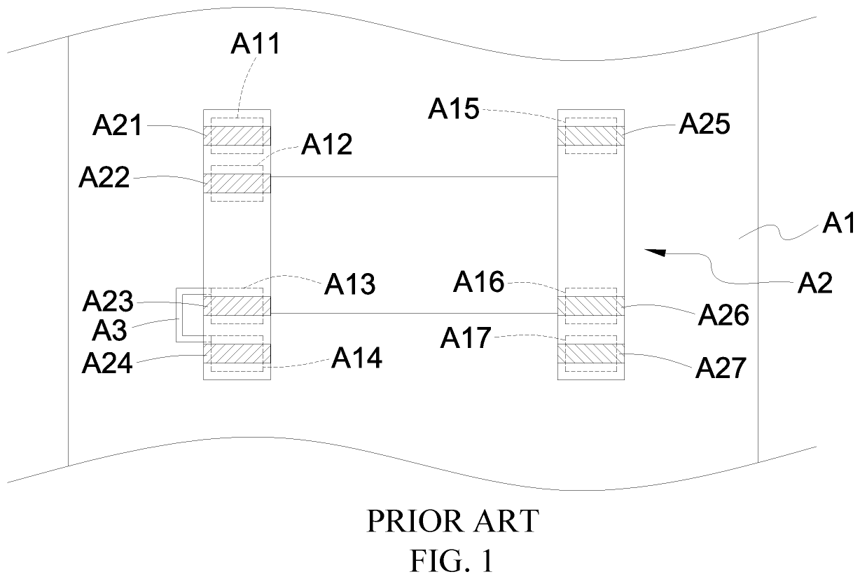

FIG. 2 is a structural schematic diagram of an inductor magnetic-core of the present invention.

FIG. 3 is a combination schematic diagram of an inductor magnetic-core structure and a circuit board of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following detailed description provides a convenient illustration for implementing exemplary embodiments of the invention. Various changes to the described embodiments may be made in the function and arrangement of the elements described without departing from the scope of the invention as set forth in the appended claims.

The foregoing and other aspects, features, and utilities of the present invention will be best understood from the following detailed description of the preferred embodiments when read in conjunction with the accompanying drawings.

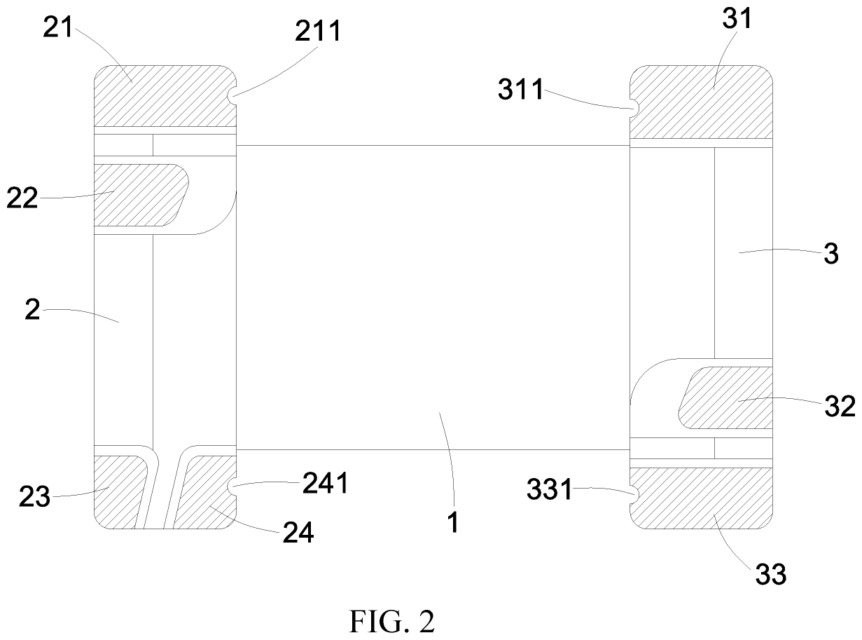

Please refer to FIG. 2, the present invention provides an inductor magnetic-core structure, which comprises a magnetic-core main-body 1 set with a first flange 2 and a second flange 3 at both ends of the magnetic-core main-body 1; wherein a first electrode 21, a second electrode 22, a third electrode 23, and a fourth electrode 24 are set on the first flange 2; wherein a first groove 211 is set on the first electrode 21, and a second groove 241 is set on the fourth electrode 24; wherein the third electrode 23 and the fourth electrode 24 are laterally adjacent and are vertical arranged with respect to the first electrode 21 and the second electrode 22; wherein a fifth electrode 31, a sixth electrode 32, and a seventh electrode 33 are set on the second flange 3; wherein a third groove 311 is set on the fifth electrode 31, and a fourth groove 331 is set on the seventh electrode 33.

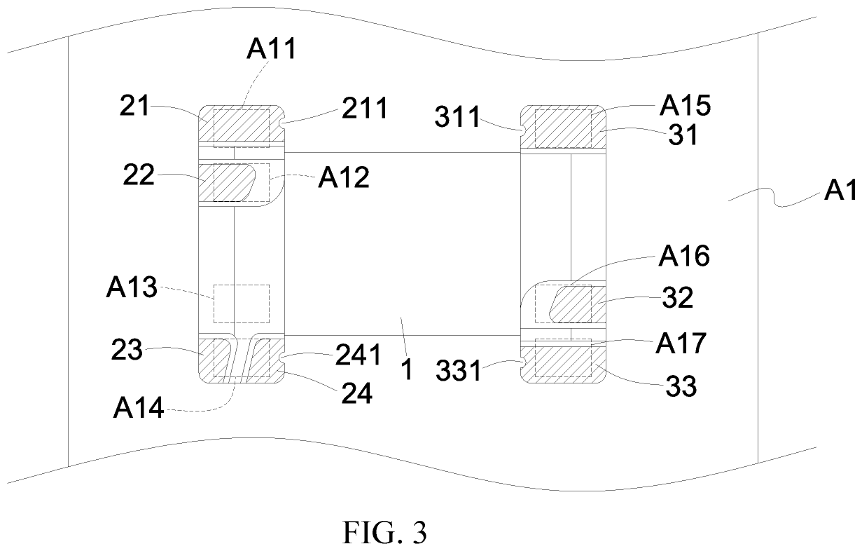

Please continuously refer to FIG. 3, the third electrode 23 and the fourth electrode 24 are set on the fourth contact-point A14 of the circuit board A1, so that it does not need to design a short-circuit line on the circuit board A1 additionally; thereby achieving the effects of convenient manufacture and reducing the circuit design.

Furthermore, through the first groove 211, the second groove 241, the third groove 311, and the fourth groove 331 set by the present invention can be used to support the fixing points for winding wires (not shown in the figure); therefore the applications and variations of the winding-wires can have more kinds and can control the winding directions of the winding-wires (clockwise or counterclockwise) according to the requirements; thereby achieving the effects of easy manufacture and easy change.

I claim:

1. An inductor magnetic-core structure, which comprises a magnetic-core main-body set with a first flange and a second flange at both ends of the magnetic-core main-body;
wherein a first electrode, a second electrode, a third electrode, and a fourth electrode are set on the first flange; wherein the third electrode and the fourth electrode are laterally adjacent and are vertical arranged with respect to the first electrode and the second electrode;
wherein a fifth electrode, a sixth electrode, and a seventh electrode are set on the second flange.

2. The inductor magnetic-core structure according to claim 1, wherein a first groove is set on the first electrode.

3. The inductor magnetic-core structure according to claim 1, wherein a second groove is set on the fourth electrode.

4. The inductor magnetic-core structure according to claim 1, wherein a third groove is set on the fifth electrode.

5. The inductor magnetic-core structure according to claim 1, wherein a fourth groove is set on the seventh electrode.
